(19) United States
(12) Patent Application Publication
(10) Pub. No.: US 2025/0282935 A1
(43) Pub. Date: Sep. 11, 2025

(54) COMPOSITE MATERIAL AND METHODS OF OBTAINING THE SAME

(71) Applicant: U.B.Q. MATERIALS LTD., Tel Aviv (IL)

(72) Inventors: Gil Felus, Kibbutz Kfar-Aza (IL); Gad Stahl, Kibbutz Kfar-Aza (IL); Jack (Tato) Bigio, Tel Aviv (IL)

(21) Appl. No.: 18/254,063

(22) PCT Filed: Nov. 24, 2021
(86) PCT No.: PCT/IL2021/051394

§ 371 Date: May 23, 2023

(30) Foreign Application Priority Data
Nov. 24, 2020 (IL) 278953

(51) Int. Cl. C08L 1/02; B29B 17/02; B29B 17/04; B29C 48/00; B29C 48/36; B29K 1/00; B29K 67/00; B29K 105/26; C08K 3/013

(52) U.S. Cl. CPC C08L 1/02; B29B 17/02; B29C 48/022; B29C 48/36; C08K 3/013; B29B 2017/0224; B29B 2017/0279; B29B 2017/0464; B29K 2001/00; B29K 2067/003; B29K 2105/26; B29K 2995/0012; B29K 2995/0063; B29K 2995/0077; B29K 2995/0082; B29K 2995/0089; C08L 2207/20

(57) ABSTRACT

The present disclosure provides a composite material comprising a homogenous blend of (a) at least about 40% w/w of non-plastic organic matter out of a total weight of the composite material, said non-plastic organic matter comprising at least cellulose; (b) between about 5% w/w and about 60% w/w plastic matter out of a total weight of said composite material, said plastic matter comprising a plurality of synthetic thermoplastic polymers; and (c) up to 15% w/w inorganic matter; wherein said composite material comprises aryl containing synthetic polymers in an amount of less than 10% out of the total weight of said composite material; and wherein said composite material is characterized by at least one of the following properties: (i) it has a notched izod impact of at least 15 h/m; and (ii) a sample of said composite material that has been subjected to injection molding has at least one of tensile strength of at least 8 MPa; and flexural strength of at least 15 MPa. Also provided is a method of preparing the composite material, the method involving use of heterogenous intake material that comprises aryl-containing synthetic polymers in an amount of less than 10% out of the total weight of said composite material; and to methods of producing articles of manufacture from the composite material.

### RELATED APPLICATIONS

The present application is a national phase filing under 35 USC 371 of International Application No. PCT/IL2021/051394, filed on Nov. 24, 2021, which claims priority of Israel Patent Application No. 278953, filed on Nov. 24, 2020, the contents of which are incorporated herein in their entirety for all purposes.

### TECHNOLOGICAL FIELD

The present disclosure concerns waste management and specifically, composite materials obtained from waste.

### BACKGROUND ART

References considered to be relevant as background to the presently disclosed subject matter are listed below:
International Patent Application Publication No. WO2010/082202
International Patent Application Publication No. WO12007949
U.S. Pat. No. 6,692,544

Acknowledgement of the above references herein is not to be inferred as meaning that these are in any way relevant to the patentability of the presently disclosed subject matter.

### BACKGROUND

Only a fraction of the generated municipal waste is actually recycled into useful products.

International patent application publication No. WO2010/082202 describes composite material having thermoplastic properties and comprising organic matter and optionally one or both of inorganic matter and plastic that can be prepared from waste such as domestic waste. The composite material is processed to obtain useful articles.

This composite material can be combined with second component comprising at least one element selected from the group consisting of vulcanized rubber and tire cords as described in WO12007949.

U.S. Pat. No. 6,692,544 describe the formation of briquettes and pellets from different types of waste material, including municipal solid waste. The briquettes and pellets are used as fuel in waste-to energy processes or are disposed at landfill sites.

### GENERAL DESCRIPTION

The present disclosure is based on the development of a technology that allows for the unexpected and significant improvement in physical properties of composite material produced from heterogenous waste. Inter alia, the technology is based on removal of selected types of synthetic polymers from the waste, as defined hereinbelow, prior to subjecting the heterogenous waste to heating and mixing under shear forces. The technology thus provides a superior composite material, method of obtaining the same and uses thereof.

Thus, in accordance with a first of its aspects, the present disclosure provides a composite material comprising a homogenous blend of
a. at least about 40% w/w of non-plastic organic matter out of a total weight of the composite material, said non-plastic organic matter comprising at least cellulose; and
b. between about 5% w/w and about 60% w/w plastic matter out of a total weight of said composite material, said plastic matter comprising a plurality of synthetic thermoplastic polymers;
c. up to 15% w/w inorganic matter;
wherein said composite material comprises aryl containing synthetic polymers in an amount of less than 10% out of the total weight of said composite material; and
wherein said composite material is characterized by at least one of the following properties:
   it has a notched izod impact of at least 15 h/m; and
   a sample of said composite material that has been subjected to injection molding has at least one of
      tensile strength of at least 8 MPa; and
      flexural strength of at least 15 MP.

In some examples, the composite material is characterized by a density of equal to or less than 1.2 gr/cm³.

In some examples, the composite material is characterized by a notched izod impact of at least 15 J/m.

In some examples, the composite material is characterized by a thermal gravimetry analysis (TGA) temperature above 200° C.

In some examples, when a sample of said composite material has been subjected to injection molding, the injection molding sample is characterized by a tensile strength the of at least 10 MPa.

In some examples, when a sample of said composite material has been subjected to injection molding, the injection molding sample is characterized by a tensile modulus of at least 1,500 MPa.

In some examples, when a sample of said composite material that has been subjected to injection molding, the injection molding sample is characterized by a flexural modulus of at least 1,500 MPa.

In some examples, when a sample of said composite material has been subjected to injection molding, has a flexural strength of at least 20 MPa; and

In some examples, the composite material comprises less than 5 mg/g silicates

The composite material disclosed herein can be characterized by any combination of two or more of the above features, each feature and each possible combination constituting a separate embodiment of the present disclosure.

As will be shown by the non-limiting examples provided herein, the composite material is exceptionally low in the amount of aryl containing synthetic polymers as compared to the amount thereof in unsorted domestic heterogenous waste.

Also disclosed herein are methods for preparing the composite material disclosed herein.

In some aspects, the method comprises subjecting particulate heterogenous intake material to at least one extrusion process, at a temperature maintained within a range of 150° C. and 200° C., to thereby obtain said composite material;
said particulate heterogenous intake material comprises:
i. at least about 40% w/w of non-plastic organic matter out of a total weight of the heterogenous waste, said non-plastic organic matter comprising at least cellulose; and
ii. between about 5% w/w and about 60% w/w plastic matter out of a total weight of said composite material, said plastic matter comprising a plurality of synthetic thermoplastic polymers;
iii. up to 15% w/w inorganic matter out of a total weight of the composite material; and
wherein said heterogenous intake material comprises aryl-containing synthetic polymers in an amount of less than 10% out of the total weight of said composite material.

In some aspects, the method comprises subjecting particulate heterogenous waste to at least one separation step that comprises removal of incompatible plastics, including at least aryl-containing synthetic polymers from said particulate heterogenous waste based on Near Infra-Red (NIR) absorbance, to obtain a heterogenous intake material; and subjecting the heterogenous intake material to at least one extrusion process at a temperature maintained within a range of 150° C. and 200° C. to thereby obtain the composite material.

In some examples, the incompatible plastics being removed include one or more halogenated polymers.

Also disclosed herein are articles of manufacture comprising a homogenous blend of a composite material as disclosed herein and at least one polyolefin.

In addition, disclosed herein are methods of producing an article of manufacture, the method comprises processing a composite material disclosed herein together with at least one polyolefin, wherein said processing comprises at least one of extrusion and molding, and wherein said processing provides homogenous blending of the composite material with the at least one polyolefin.

### BRIEF DESCRIPTION OF THE DRAWINGS

In order to better understand the subject matter that is disclosed herein and to exemplify how it may be carried out in practice, aspects will now be described, by way of non-limiting example only, with reference to the accompanying drawings, in which:

FIGS. 1A-1B are graphs of combined thermogravimetry (TG) and Differential Scanning calorimetry (DSC) analyses (TG-DSC), where FIG. 1A is a DSC graph of a composite material having a particle size of about 1.4 mm (“Q1.4”) from 0° C. to 1,500° C. in 50° increase every one minute; FIG. 1B is a DSC graph of a composite material having a particle size of about 0.9 mm (“Q0.9”) from 0° C. to 1,500° C. in 50° increase every one minute.

FIG. 2 is a Fourier-transform infrared spectroscopy of composite materials according to the present disclosure including a composite material having particles dimensions of 0.9 mm (“Q0.9”), composite material having particles dimensions of 1.4 mm (“Q1.4”)

### DETAILED DESCRIPTION

Producing useable composite materials from heterogeneous plastic-containing waste faces many challenges.

When different types of plastics are melted together, they tend to phase-separate, like oil and water. The phase boundaries cause structural weakness in the resulting composite material. In other words, polymer blends from recycled heterogeneous waste are useful in only limited applications. To overcome physical weakness, each time heterogenous plastic waste is recycled, additional virgin materials may be added to help improve the integrity of the material.

It has now been found that certain plastics are undesirable for producing composite materials from heterogenous plastic waste. Specifically, it has now been realized that certain synthetic plastics, like polyvinyl chloride (PVC) and polyethylene terephthalate (PET), are considered to be incompatible with other plastics typically recycled e.g., polyolefins.

In some examples, the incompatibility can be defined by their having a melting point above that of recyclable polyolefins (e.g. above 200° C.) and thus may not sufficiently melt during the processing of the heterogenous waste and thus may act in a similar manner as metals and/or ceramics in the composite material. Without being bound by theory, it seems that plastics with a melting point above the temperature of processing the heterogenous waste disrupt the homogeneity of the resulting composite material, thereby structurally weakening the resulting composite material. The presence of such plastics, i.e. having a melting point above the temperature at which the heterogenous waste is processed, may impose a challenge in the formation of composite materials for use in the recycling industry.

In some examples, the incompatibility can be defined by plastics that are susceptible of releasing toxic volatiles during the processing of the heterogenous waste, this including, for example, PVC.

Another challenge is the presence of impurities in the heterogenous waste. It has been realized by the inventors of the present invention that inorganic materials like metals and ceramics act as impurities, as they are not miscible/dissolvable during the processing of the heterogenous waste. The presence of such impurities negatively effects the homogeneity of the resulting composite material. At times, these inorganics create “voids” in the resulting composite material and these voids may cause structural weakness in the resulting composite material. At times, the presence of the inorganic materials also damages the equipment used to process heterogeneous waste and produce the useful and durable composite materials in accordance with the present disclosure.

Based on the realization that it may be advantageous to remove incompatible plastics from the waste prior to processing, the present disclosure provides composite material and methods for obtaining the same from heterogenous waste material (such as municipal waste) from which plastics that are incompatible with the recyclable polyolefins have been removed (thus the waste comprises only low amounts, if any). Such processed heterogenous waste can be regarded as a modified heterogenous waste. The plastics incompatible with polyolefins will include at least aryl-containing synthetic polymers, such as polystyrenes and PET, and optionally also halogenated polymers, such as PVC. The composite material can be molded into various useful articles of manufacture, due to a thermoplastic behavior of the resulting composite material. The composite materials, in turn, have unexpectedly beneficiary strength.

Thus, the present disclosure provides a composite material comprising a homogenous blend of non-plastic organic matter, a plurality of different types of synthetic plastic matter comprising a plurality of thermoplastic polymers and inorganic matter.

In the context of the present disclosure, when referring to a “homogenous blend” it is to be understood to encompass a mass comprising an essentially evenly distributed particulate matter therethrough, such that any cross section along the composite material would reveal an essentially similar view of matter within a continuous mass; or in other words, mass having a substantially even distribution of particulate matter, such that any cross-section along the composite material reveals a substantially similar view of mater within a continuous mass. Further, when referring to a homogenous blend it is to be understood as excluding a composite material made of or comprising discrete layers or discrete sections of different/distinguishable materials.

The composite material has defined ranges for each of these components (as further discussed below) and is characterized by the following:
the plurality of thermoplastic polymers in the composite material comprises at most 10% w/w and preferably less plastics that are incompatible with polyolefins; and
the plastics incompatible with polyolefins comprise at least one type of aryl-containing compounds.

In the context of the present disclosure, and as noted above the amount of the of aryl-containing synthetic polymers (including one or more type of aryl containing synthetic polymers), if present, is less than about 10% out of the total weight of said composite material. At times, the amount of the aryl containing synthetic polymers is less than about 9% w/w; at times, less than about 8% w/w; at times, less than about 7% w/w; at times, less than about 6% w/w; at times, less than about 5% w/w; at times, less than about 4% w/w; at times, less than about 3% w/w; at times, less than about 2% w/w; at times, less than about 1% w/w.

In some examples, the polymers incompatible with polyolefin also comprise one or more halogenated polymers. In some examples, the amount of the halogenated polymers, if present in the composite material is less than about 1% w/w out of the total weight of said composite material.

In some examples, the composite material disclosed herein has a density of equal to or less than 1.2 gr/cm³.

In some examples, the composite material disclosed herein has a notched izod impact of at least 15 J/m.

In some examples, the composite material has a thermal gravimetry analysis (TGA) temperature above 200° C.

In some examples, the composite material comprises less than 5 mg/g silicates.

In some examples, a sample of said composite material that has been subjected to injection molding, has at least one of
tensile strength the of at least 8 Mpa
tensile modulus of at least 1,500 MPa;
flexural modulus of at least 1,500 MPa;
flexural strength of at least 15 MPa.

The composite material disclosed herein can be characterized by any combination of the above features, including one, two, three, four or more of the above features, each combination constituting a separate embodiment of the present disclosure.

In some examples, the composite material is characterized by a notched izod of at least 15 j/m, and a tensile strength of at least 8 MPa and flexural strength of at least 15 MPa, when the tensile strength and flexural strength are determined on a injection molded sample of the composite material.

As described above, the composite material comprises non-plastic organic matter. The non-plastic organic matter is present in an amount of at least about 40% w/w out of the total weight of the composite material. In some examples, the non-plastic organic matter is present in an amount of at least about 45%, at times, at least about 50%, at times at least about 55%, at times at least about 60%, at times at least about 65%, at times, at least about 70%, at times at least about 75%, at times at least about 80%, at times at least about 85%, at times, at least about 90%, at times, in an amount of about 95%.

In some examples, the amount of non-plastic organic matter can be within any range between the above recited lower and upper limits. For example, the non-plastic organic matter can be in any range within the range of between about 40% and 95%, e.g. between about 40% and 90%, or between about 50% and 85%, or between about 65% and 90% etc.

This non-plastic organic matter comprises at least cellulose. In some examples, the organic matter may further comprise hemicellulose and/or lignin.

In the context of the present disclosure, when referring to cellulose it is to be understood to encompass any cellulose containing molecule, including modified cellulose, such as paper, cardboard, vegetables and plants, all typically found in municipal waste.

The presence and amount of cellulose in the composite material can be determined using thermal analysis methods including Differential Scanning calorimetry (DCS, allows to determine synthetic polymers content) and Thermogravimetric Analysis (TGA, allows for determination of lignocellulose content and inorganic content).

As described above, the composite material comprises plastic matter. The plastic matter comprises a plurality of synthetic thermoplastic polymers and optionally thermoset polymers.

The plastic matter is present in an amount of at least about 5% w/w out of the total weight of the composite material, at times, in an amount of at least about 6%, at times, in an amount of at least about 7%, at times, in an amount of at least about 8%, at times, in an amount of at least about 9%, at times, in an amount of at least about 10%, at times, in an amount of at least about 11%, at times, in an amount of at least about 15%, at times, in an amount of at least about 20%, at times in an amount of at least about 25%, at times in an amount of at least about 30%, at times in an amount of at least about 35%.

The plastic matter is present in an amount of up to about 60% w/w out of the total weight of the composite material, at times, in an amount of up to about 55%, at times in an amount of up to about 40%, at times, in an amount of up to about 35%, at times in an amount of up to about 30%, at times, in an amount of up to about 25%, at times in an amount of up to about 20%, at times, in an amount of up to about 15%, at times in an amount of up to about 12%.

In some examples, the amount of plastic matter can be within any range between the above recited lower and upper limits. For example, the plastic matter can be in any range within the range of between about 5% and 60%, e.g. between about 8% and 50%, between about 5% and 30%, between about 8% and 30%, or between about 10% and 40%, or between about 10% and 30%, or between about 5% and 15% etc.

The plastic matter in the composite material is heterogenous. In this context it is to be understood that the plastic matter cannot be composed solely of a virgin plastics or plastics of similar properties, e.g. only one or more polyolefins. Thus, in the context of the present disclosure it is to be understood that the plastic matter comprises one or more polyolefins as well as at least one other non-olefin polymer.

In some examples, the non-olefin polymer does not contain or contains only less than 10%, or even less than 5% aryl-containing compounds (i.e. the aryl containing synthetic polymers).

In some examples, the non-olefin polymer does not contain or contains only less than 1% halogenated polymer(s), specifically does not contain or contains only less than 1% PVC.

In some examples, the composite material is one that has less than 10% w/w polymers having a melting point range of at least 200° C. or higher. At times, the composite material comprises less than 9% w/w, or less than 8% w/w; or less than 7% w/w, or less than 6% w/w, or less than 5% w/w, or less than 4% w/w or less than 3% w/w or even less than 2% w/w polymers having a melting point range of at least 200° C. or higher.

In some examples, the plastic matter in the composite material, other than polyolefins (i.e. non-polyolefin polymer), comprises polyacrylonitriles.

In some examples, plastic matter in the composite material, other than polyolefin (i.e. non-polyolefin polymer), comprises polybutadienes.

In some examples, plastic matter in the composite material, other than polyolefin (i.e. non-polyolefin polymer), comprises polycarbonates.

In some examples, plastic matter in the composite material, other than polyolefin (i.e. non-polyolefin polymer), comprises polyamides (PA).

In some examples, plastic matter in the composite material, other than polyolefin (i.e. non-polyolefin polymer), comprises ethylene vinyl alcohol copolymers (EVOH).

In some examples, plastic matter in the composite material, other than polyolefin (i.e. non-polyolefin polymer), comprises polyurethane (PU).

In some examples, plastic matter in the composite material, other than polyolefin (i.e. non-polyolefin polymer), comprises polyethylene terephthalate (PET) yet, as noted above, the PET is present in an amount of less than 10% w/w; or less than 9% w/w; or less than 8% w/w; or less than 7% w/w; or less than 6% w/w; or less than 5% w/w; or less than 4% w/w; or less than 3% w/w, or even less than 2% w/w.

In some examples, the plastic matter comprises at least two types of polyolefins. For examples, high density polyethylene (HDPE), low density polyethylene (LDPE), polypropylene (PP).

The composite material comprises a heterogenous blend of plastics, thus including at least one polyolefin and at least one non-olefin compounds. Preferably, the composite material comprises a plurality (more than 2) of polyolefin plastics and a plurality (more than 2) non-polyolefins.

In some examples, the plastic matter comprises thermosets, even though such would constitute a small portion of the composite material. In some examples, the plastic matter comprises up to 1% thermosets. Some non-limiting examples of thermosets that can be present in the composite material include vulcanized rubber, thermoplastic polymers vulcanized (TPV) and/or polyurethanes (PU).

As described above, the composite material may comprise inorganic matter. The inorganic matter is present in an amount of up to about 15% w/w, at times in an amount of up to about 10%; at times in an amount of up to 9%; at times in an amount of up to 8%; at times in an amount of up to 7%; at times in an amount of up to 6%; at times in an amount of up to 5%; at times in an amount of up to about 4%, 3%, 2% or even 1%.

In some examples, the amount of inorganic matter can be within any range between the above recited lower and upper limits. For example, the inorganic matter can be in any range within the range of between about 1% and 15%, e.g. between about 5% and 10%, or between about 1% and 10%, or between about 3% and 8% etc.

In some examples, the inorganic matter within the composite material refers to material that typically exists in municipal, household and/or industrial waste. This includes, without being limited thereto, sand, stones, glass, ceramics and other minerals, as well as metals, including e.g. aluminum, iron, copper.

In some examples, the inorganic matter comprises silicates, in an amount further discussed below.

In the context of the present disclosure, when referring to the composite material lacking a detectable amount of a specific synthetic plastic or having an amount that is less than a defined range it is to be understood as a determination made using conventional analytical techniques.

In one example, the composite material can be characterized by having no detectable amount or an insignificant amount of halogenated polymers.

In some examples, the composite material can be characterized by having no detectable amount or an insignificant amount (less than about 10% w/w, or less than 9% w/w; or less than 8% w/w; or less than 7% w/w; or less than 6% w/w; or less than 5% w/w; or less than 4% w/w; or less than 3% w/w; or less than 2% w/w;) of aryl-containing synthetic polymers. The presence (in insignificant amount) or absence of detectable amount of aryl-containing synthetic polymers in the composite material can be determined using NIR technology, such as the system disclosed herein.

In the context of the present disclosure when referring to “aryl-containing synthetic polymers” or “aryl-containing compounds” it is to be understood as referring to high molecular weight compounds, including preferably polymers containing aryl-containing organic moiety as a monomer unit of the polymer.

In some examples, the aryl group of the aryl-containing organic compound comprises a phenyl group.

In some other examples, the aryl group of the aryl-containing organic compound comprises a styrene group.

In preferred examples, the aryl-containing organic compound comprises a polymer, such as, without being limited thereto, polystyrene, high impact polystyrene, (HIPS), acrylonitrile butadiene styrene (ABS), polyethylene terephthalate (PET), each example being regarded as an independent aspect of the present disclosure.

In some examples, the aryl-containing synthetic polymers comprises or is polystyrene.

In some examples, the aryl containing synthetic polymers comprises at least PET.

As will be shown in the non-limiting examples, after NIR treatment the waste contains less than twice the amount of PET in the absence of the NIR treatment.

In some examples, the NIR treatment is employed to remove also halogenated polymers. In the context of the present invention, the term “halogenated polymers” encompasses any synthetic plastic polymer such as PVC and fluorine-derived fluorinated ethylene propylene (FEP). Specifically, the composite material can be characterized by having no detectable amount or an insignificant amount of PVC. The presence or absence of the halogenated polymer and specifically PVC in the composite material can be detected using Near Infra-Red (NIR) technologies. In some examples, halogenated polymers and specifically PVC is detected using NIR system, such as SESOTEC MN 1024, as further discussed below in the Examples section, forming an integral part of the present disclosure.

In some examples, the composite material disclosed herein has been shown to have one or any combination of beneficiary physical characteristics, these include, inter alia, density, Notched Izod Impact, a unique thermal gravimetry profile (TGA), tensile strength, tensile modulus, flexural modulus and flexural strength.

In some examples, the composite material is defined by having a specific density level. In the context of the present disclosure when referring to density it is to be understood as density of the composite material being equal or less than 1.2 gr/cm². Without being bound by theory, this density may result from limiting and/or removing the amount of inorganics (metal, glass, silica, etc.) . . . . As will be shown in the non-limiting examples, the disclosed technology provided a lighter composite material as compared to that of WO2010/082202, which is considered to be a commercial benefit (e.g. in terms of cost per volume).

The density can be determined using Density ISO1183-1 (ASTM D792 procedure) as further described below in connection with the Examples, which form an integral part of the present disclosure.

In some other examples, the composite material is defined by its Notched Izod Impact. In the context of the present disclosure, when referring to Notched Izod Impact of the composite material disclosed herein it is to be understood as one being at least 15 J/m.

Without being limited thereto, the Notch Izod Impact, which is a measurement of resistance of the composite material to impact from a swinging pendulum, can be determined using ASTM D256 (ISO 180) as further described below in connection with the Examples, which form an integral part of the present disclosure

In some examples, the Notched Izod Impact of the composite material is at least 16 J/m, at times at least 17 J/m, at times at least 18 J/m, at times at least 19 J/m, at times at least 20 J/m, at times at least 21 J/m, at times at least 22 J/m, at times at least 23 J/m, at times at least 24 J/m, at times at least 25 J/m, at times at least 26 J/m.

In some examples, the Notched Izod Impact is within the range of 15 J/m and 50J/m, at times within the range of 20 J/m and 40J/m, at times within the range of 20 J/m and 35J/m; at times within the range of 18 J/m and 40J/m; at times within the range of 15 J/m and 35J/m.

In some examples, the composite material is characterized by a unique thermogravimetry analysis (TGA) with a weight loss greater than 5%, at a temperature above 200° C.; at times at a temperature above 210° C.; at time at a temperature above 215° C. As appreciated, the TGA measures the weight loss as a function of temperature. A loss of 5% means start of degradation. The composite material disclosed herein was found to be more stable than waste derived composite materials, such as that described in WO2010/082202 (the “reference composite material”) where the upper temperature limit was <200° C. As appreciated, the higher the temperature at which there is more than 5% weight loss, the more stable the material is (which means that a wider processing temperature window is achieved). For example, in the non-limiting examples provided herein, it is shown that two samples of the composite material disclosed herein (Q0.9 and Q1.4) have a TGA temperature above 210° C. (218° C. and 224° C., respectively), which are higher than the temperature of the reference composite material being 170° C.

The TGA can be provided using a thermogravimetry—Differential Scanning calorimetry as described hereinbelow in the Examples section forming an integral part of the present disclosure.

Generally, as appreciated by those versed in the art, TGA uses heat to force reactions and physical changes in materials. TGA provides quantitative measurement of mass change in materials associated with transition and thermal degradation. TGA records change in mass from dehydration, decomposition, and oxidation of a sample with time and temperature. Characteristic thermogravimetric curves are given for specific materials and chemical compounds due to unique sequence from physicochemical reactions occurring over specific temperature ranges and heating rates. These unique characteristics are related to the molecular structure of the sample. DSC is a thermal analysis technique in which the heat flow into or out of a sample is measured as a function of temperature or time, while the sample is exposed to a controlled temperature program. It allows to evaluate material properties such as glass transition temperature, melting, crystallization, specific heat capacity, cure process, purity, oxidation behavior, and thermal stability.

The composite material can also be characterized, in accordance with some examples, by its tensile properties as determined from an injected molded sample prepared therefrom. For example, a sample for determining the physical properties of the composite material can be prepared by subjecting an amount of the composite material to following injection molding conditions. The specimen's preparation for injection molding can include fusion at 170-180° C. and 350 rpm by an extruder, granulating the extrudate into granules of essentially uniform size, and injection molding the granules by an injection molding machine, at 170-180° C. to obtain the test specimens. The test specimens were conditioned for at least 48 hours at 23±2° C.

Measurements of tensile properties of the injection molded sample can be provided using ISO 521-2:1996. According to ISO521-2, a Specimen Type 1A can be used with a test speed of 50 mm/min; the specimen comprising the following dimension: overall length ≥150-200 mm, length of narrow parallel sided portion=80±2 mm, radius 20-25 mm, distance between broad parallel sided portions 104-113 mm, widths at ends=20±0.2 mm, width at narrow portion 10±0.2 mm, preferred thickness 4±0.2 mm, gauge length 50±0.5 mm and initial distance between grips=115±1 mm.

In accordance with some examples, the composite material can be characterized, by a tensile strength of at least 8 MPa.

In some further examples, the tensile strength of the injection molded sample of the composite material is at least 9 MPa, at times at least 10 MPa, at times at least 11 MPa, at times at least 12 MPa, at times at least about 13 MPa.

In some further examples, the tensile strength of the injection molded sample of the composite material is at most 25 MPa, at most 22 MPa, at most 20 MPa.

In some examples, the tensile modulus of the injection molded sample of the composite material is at least 1,500 MPa, at times at least 1,600 MPa, at times at least 1,700 MPa, at times at least 1,800 MPa, at times at least 1,900 MPa, at times at least 2,000 MPa, at times at least 2,100 MPa.

In some examples, the tensile modulus of the injection molded sample of the composite material is at most 3,000 MPa.

The composite material can also be characterized by its flexural properties. flexural properties can be determined according to ISO 178. According to ISO 178, specimen dimensions were: Length=80±2 mm Width=10±0.2 thickness=4±0.2 mm. Further, according to ISO 178, test speed was 5 mm/min. Typically, the test results were the average of at least 5 specimens' measurements, as further discussed below.

In some examples, the flexural modulus of the injection molded sample of the composite material is at least 1,500 MPa, at times at least 1,600 MPa, at times at least 1,700 MPa, at times at least 1,800 MPa, at times at least 1,900 MPa, at times at least 2,000 MPa, at times at least 2,100 MPa, at times at least 2,200 MPa, at times at least 2,300 MPa, at times at least 2,400 MPa, at times at least 2,500 MPa, at times at least 2,600 MPa, at times at least 2,700 MPa.

In some examples, the flexural modulus of the injection molded sample of the composite material is at most 7,000 MPa, at times at most 6,000 MPa, at times at most 5,000 MPa; at times at most 4,000 MPa; at times, at most 3,000 MPa.

In some examples, the flexural strength of the injection molded sample of the composite material is at least 15 MPa, at times at least 16 MPa, at times at least 17 MPa, at times at least 18 MPa, at times at least 19 MPa, at times at least 20 MPa, at times at least 21 MPa, at times at least 22 MPa, at times at least 23 MPa, at times at least 24 MPa.

In some examples, the flexural strength of the injection molded sample of the composite material is at most 50 MPa; at times, at most 40 MPa; at times, at most 30 MPa.

Without being limited thereto, flexural strength was determined according to ISO 178. According to ISO178, specimens with the following dimensions are prepared: Length=80±2 mm Width=10±0.2 thickness=4±0.2 mm. Test conditions include test speed of 5 mm/min. In the Examples below, at least 5 specimens were tested by Tinius Olsen H10KT apparatus. The test results were the average of these measurements.

The composite material disclosed herein can also be characterized by the amount of silicates. In accordance with some examples, the amount of silicate is less than 10 mg/g. The amount of silicates as well as other inorganic elements, can be determined using argon plasma, in a technology of Inductively Coupled Plasma Atomic Emission spectroscopy (ICP-AES), the details of which are provided hereinbelow in the Examples, which form an integral part of the present disclosure.

In some examples, the silica amount in the composite material is at most 7 mg/g, at times at most 6 mg/g, at times at most 5 mg/g, at times at most 4 mg/g, at times at most 3 mg/g, at times at most 2 mg/g, at times at most 1 mg/g.

In some examples, the composite material comprises no detectable amount of silica. At times, the composite material comprises between 0.1 and 5 mg/g silica, at times, between 1 mg/g and 10 mg/g silica; at times between 5 mg/g and 10 mg/g silica; at times between 0.5 mg/g and 2 mg/g, at times any range between 1 mg/g and 10 mg/g.

In some examples, the composite material can be characterized by its surface energy, this being determined according to ASTM D2578-84 using commonly known and commercially available Dyne Test Pens. In some examples, the surface energy is above 35 dyne/cm; at times, about 36 dyne/cm. At times, the surface energy is between 35 and 40 dyne/cm.

The composite material can also be characterized by its flame retardancy, or flammability as defined by its Limited Oxygen Index (LOI) ISO 4589-2:2017. In some examples, the composite material is defined by a LOI of up to 21.5%. For comparison LOI of PE or PP equals 17 which means that these polymers are more flammable.

The composite material of the present disclosure can also be characterized by the presence of DNA matter as detected using chloroform:isoamyl alcohol (24:1) (CTAB) solution in a conventional DNA extraction protocol, such as that described by Yi, S., Jin, W., Yuan, Y. and Fang, Y. (2018). An Optimized CTAB Method for Genomic DNA Extraction from Freshly-picked Pinnae of Fern, Adiantum capillus-veneris L. Bio-protocol 8(13): e2906. DOI: 10.21769/BioProtoc.2906 (see also the Examples, which form an integral part of the present disclosure).

The composite material of the present disclosure can also be characterized by the presence of chlorophyll, as detected using conventional protocols, such as that described by Yi, S., Jin, W., Yuan, Y. and Fang, Y. (2018). An Optimized CTAB Method for Genomic DNA Extraction from Freshly-picked Pinnae of Fern, Adiantum capillus-veneris L. Bio-protocol 8(13): e2906. DOI: 10.21769/BioProtoc.2906 (see also the Examples, which form an integral part of the present disclosure).

The composite material of the present disclosure can also be characterized by the presence of not more than 1.5 mg/g ferrous (Fe) material, as determined using ICP-AES, as described herein.

The composite material of the present disclosure can also be characterized by the presence of not more than 5 mg/g Sodium (Na), at times even not more than 4 mg/g, or even not more than 3 mg/g or even not more than 2 mg/g, as determined using ICP-AES, as described herein.

The composite material of the present disclosure can also be characterized by the presence of not more than 5 mg/g Al; at times even not more than 4 mg/g, as determined using ICP-AES, as described herein.

The composite material of the present disclosure can also be characterized by the presence of not more than 5 mg/g potassium; at times not more than 4 mg/g; at times even not more than 3 mg/g or even not more than 2.5 mg/g, as determined using ICP-AES, as described herein.

The composite material of the present disclosure can also be characterized by the presence of not more than 5 mg/g magnesium (Mg); at times not more than 4 mg/g; at times even not more than 3 mg/g or even not more than 2.5 mg/g, as determined using ICP-AES, as described herein.

The composite material can be prepared from heterogenous waste. In the context of the present disclosure, when referring to “heterogenous waste” it is to be understood as material comprising a combination of a heterogenous blend of synthetic plastic matter, non-plastic organic matter including at least cellulose and inorganic matter.

For the purpose of producing the composite material disclosed herein, the blend of synthetic plastic matter comprises a plurality of polymers, and the plurality of polymers containing less than 10% w/w aryl containing synthetic polymers.

In some examples, the blend of synthetic polymers (1) is lacking a detectable amount of plastics that are incompatible with polyolefins or comprise an insignificant amount (i.e. less than 10% w/w) of plastics incompatible with polyolefins; and/or (2) is lacking a detectable amount of halogenated polymers such as polyvinyl chloride (PVC) or comprises an insignificant amount of halogenated polymers, such as PVC, the insignificant amount being an amount that is less than about 1% w/w out of the total weight of said composite material, and/or (3) is lacking a detectable amount of aryl-containing synthetic polymers or comprises an insignificant amount of aryl-containing synthetic polymers, the insignificant amount being an amount that is less than about 10% as defined hereinabove, and preferably less than 5% w/w or even preferably less than 4% w/w. The heterogenous waste comprising the blend of synthetic plastic matter, including the insignificant amounts of or even lacking detectable amounts of the incompatible plastics defined hereabove, is referred to herein as the heterogenous intake material.

The heterogenous waste prior to removal of the plastics incompatible with polyolefins (preferably PET) can be obtained from municipal, industrial and/or household waste. This heterogenous waste then is subjected to a sorting process to provide the heterogenous intake material comprising the plurality of heterogenous plastic matter, non-plastic organic matter and inorganics, but comprising less than 10% aryl containing synthetic polymers (e.g. PET), as described above.

The heterogenous intake material is particulated to form a particulated heterogeneous intake material and then processed into a product. The product can constitute an ingredient for the production of articles of manufacture, or the product is an end product, i.e. a useful article of manufacture.

Thus, the present disclosure thus provides a method of producing a composite material from heterogenous intake material, in accordance with the present disclosure from which useful articles of manufacture can be produced, the intake material comprising:
i. at least 40% w/w of non-plastic organic matter out of a total weight of the heterogenous intake material, said non-plastic organic matter comprising at least cellulose;
ii. between about 5% w/w plastic matter and about 60% w/w plastic matter out of a total weight of said heterogenous intake material, said plastic matter comprising a plurality of thermoplastic polymers; and
iii. up to 15% inorganic matter out of a total weight of the heterogenous intake material.

In one example, the method disclosed herein comprises subjecting heterogenous intake material as defined above to at least one extrusion process under conditions that comprise internal (running) temperature of between about 150° C. and about 200° C. to thereby obtain said composite material;

wherein the plurality of thermoplastic polymers comprises aryl containing synthetic polymers in an amount of less than 10% w/w out of the total weight of the composite material; at times even less than 9% w/w; at times, even less than 8% w/w; at times even less than 7% w/w; at times even less than 6% w/w; at times, even less than 5% w.w, out of the total weight of the composite material.

In some examples, the composite material comprises less than 10% w/w of plastics incompatible with polyolefins, the 10% w/w maximal amount includes at least PET.

The heterogenous intake material is particulated prior to extrusion or is fed into an extruder a form of particles.

In some examples, the at least one extrusion process also comprises retention time within the extruder of at least 4 min., at times, of at least 5 min., preferably at times at least 5.5 min. This retention time is specifically relevant when the extruder is a single screw extruder. In this connection, it is noted that a shorter retention time can be applied when using a twin-screw extruder. Yet, a single screw extruder and an elongated (above 4 min.) retention time is preferable.

In yet sone other example, the particulate heterogenous intake material being subjected to at least one extrusion process comprises a plurality of thermoplastic polymers that comprises an insignificant amount of aryl-containing synthetic polymers, such as polystyrene, the insignificant amount being an amount that is less than about 10%; at times, less than about 9%; at times, less than about 8%; at times, less than about 7%; at times, less than about 6%; at times, less than about 5%; at times, less than about 4%; at times, less than about 3%.

In some examples, the particulate heterogenous intake material being subjected to at least one extrusion process comprises a plurality of thermoplastic polymers that comprises an insignificant amount of halogenated polymers, such as polyvinyl chloride (PVC), the insignificant amount being an amount that is less than about 1% w/w out of the total weight of said composite material.

In yet another example, the presently disclosed method comprises subjecting particulate heterogenous intake material to a separation step that comprises removal of polymers having a melting point above 200° C.

In some further examples, the presently disclosed method comprises subjecting particulate heterogenous intake material to a separation step that comprises removal of polyvinyl chloride.

In some further examples, the presently disclosed method comprises subjecting particulate heterogenous intake material to a separation step that comprises removal of one or more aryl-containing synthetic polymers from the particulate heterogenous intake material based on Near Infra-Red (NIR) absorbance, to obtain a sorted heterogenous waste.

The heterogenous intake material is provided in particulate form.

In accordance with some examples, the heterogeneous intake material is obtained from a heterogenous unsorted waste that is a priori subjected to one or more pre-processing steps of a raw, heterogenous unsorted waste that eventually result in the particulate intake material, suitable for the methods disclosed herein.

In the context of the present disclosure, the term “raw heterogenous waste” or in short “raw waste” refers to unsorted heterogenous waste material, namely, without being subjected to any industrial sorting process.

In some examples, the raw heterogenous waste material undergoes a pre-sorting process where large undesired waste items are removed. For example, the raw waste can be pre-sorted to remove any one of metals, glasses, and large minerals. The pre-sorting can be conducted manually, e.g. by conveying the raw waste on a conveyor belt and identifying the undesired large waste items.

In addition, or alternatively, the pre-sorting comprises separation using magnetic forces (magnet-based separation), typically for the separation and removal of ferrous metals.

In addition, or alternatively, the pre-sorting comprises separation using eddy current separator, typically for the removal of non-ferrous metals.

The raw waste material can also be subjected to a drying process. In the context of the present disclosure when referring to drying it is to be understood as removing a portion of the water from the raw waste material. The drying should not be construed as removing all the water from the waste. In some examples, the raw waste comprises about 30% to 40% w/w water and drying involves removal of at least 50% of the water content; at times, at least 60% of water content; at times at least 70% water content; at times at least 80% water content; at times at least 90% water content; at times, at least 95% water content. The resulting waste material can then be regarded as a dried waste material.

In some examples, the dried waste material comprises at most 11% w/w water; at most 10% w/w water; at times, at most 9% water; at times, at most 8% water; at times, at most 7% water content; at times, at most 6% water content.

Drying can be achieved by any means known in the art.

In some examples, drying is achieved by placing the waste outdoors and allowing it to dry. In some other examples, drying is achieved by placing the waste under a stream of dry air and/or in an oven chamber and/or by squeezing the liquid out.

In the drying process, water and at times some volatile liquids are removed. This may include liquids having a vapor pressure of at least 15 mmHg at 20° C., e.g. ethanol.

In some examples, the drying is achieved by a bio-drying process utilizing bacteria inherently present in the waste. To this end, the waste material is typically placed in a temperature-controlled environment. In some examples, bio-drying is performed at a temperature maintained around 70° C.

In some examples, bacteria are added to the waste material (e.g. to the pre-sorted waste material) so as to induce or enhance the bio-drying process.

While not wishing to be bound by theory, it is currently believed that the residual remaining water content plays a role in the chemical process that occurs that converts the dried waste material into the composite material of the present disclosure.

The waste material, preferably dried waste material is then subjected to a particulating stage, to obtain the particulate waste material utilized in the methods disclosed herein.

In the context of the present disclosure, the term “particulating” should be understood to encompass any process that involves size reduction of the waste material. Particulating can take place by any one or combination of granulating, shredding, chopping, dicing, cutting, crushing, crumbing, grinding etc.

In some examples, the particulating comprises shredding the waste (dried or non-dried, yet preferably dried) to particles of an average size below 40 mm, at times, below 30 mm; at times below 20 mm.

Notably, due to the friction within the shredder, the particulating may result in further moisture reduction (e.g. by an additional of 2%-3%).

In some preferred examples, the particulate waste is then subjected to a selective separating process (also referred to as a cleaning process) where remnant metal and/or mineral particles (“impurities”) are removed.

In some examples, remnant impurities are removed by subjecting the particulate matter into an air separator system where heavy particles (e.g. metal particles and/or minerals) are eliminated by gravitation while a light waste fraction is collected and/or conveyed to the next process step.

The resulting the light fraction would comprise low amount of metal and minerals. Without being bound thereto, it is believed that the fraction comprises at most 1% w/w metals (ferrous and non-ferrous) and at most 5% minerals.

One feature of the presently disclosed method involves treatment of the waste material to selective separation using Near Infra-Red (NIR). NIR-based separation allows the optical sorting out of undesired plastic materials from other plastic waste based on polymer type (based on resins' wavelength signatures). As appreciated by those versed in the NIR technology, the NIR based separating system is a programed to be able to identify many polymers and other chemical compounds. The operator of the system defines what compounds will stay and what will be sorted out. More specifically, the NIR separation step makes use of systems that are equipped with algorithms for each substance to be removed, including polymers incompatible with polyolefins, such as polymers having a melting point above 200° C. or even above 210° C.; and/or halogenated polymers and/or aryl-containing synthetic polymers and optionally other polymers, as desired. This algorithm enables the identification and separation of each compound accordingly. In this connection, it is appreciated by those versed in the art each chemical entity has a complicated IR spectrum which is the “fingerprint” ID of the chemical entity. This fingerprint can be found in any publicly available “Chemical Atlas” and is recognized by computer programs.

In some examples and as already noted above, the NIR-based separation is operated in a manner allowing for the separation of at least a polymer that are recognized in the art as being incompatible with polyolefin.

In some examples and as already noted above, the NIR-based separation is operated in a manner allowing for the separation of at least halogenated polymeric resins, such as polyvinyl chloride (PVC or vinyl) resins.

In some additional or alternative examples, also already noted above, the NIR-based separation is operated in a manner allowing for the separation of aryl-containing synthetic polymers, and preferably styrene or polystyrene organic polymers.

In some further examples, the heterogenous intake material is characterized by its ash levels. In some examples, the ash content in the heterogenous intake material is below 10% w/w; at times below 8% w/w; at times below 6% w/w or even below 5% w/w.

Ash levels in the intake material (as well as in the final composite material) can be determined according to ISO 3451 method A, making use of two test portions of 5 gr each one and burned at 950±500 C for 30 min.

The resulting particulate and sorted waste material is referred to herein by the term “heterogenous intake material” or, at times, by the term “sorted heterogenous intake material”.

The heterogenous intake material is then subjected to at least one extrusion process. The conditions of extrusion involve, at least
an internal (running) temperature equal or below 200° C.; at times between about 150° C. and about 200° C.; at times between about 120° C. and about 180° C.; at times between 160° C. and 200° C., at times between 150° and 180° C.;
a minimal retention time within the extruder of at least 2.0 minutes; at times, of at least 2.5 minutes, at times, of at least 3 minutes, at times of at least 3.5 minutes at times, of at least 4 minutes, at times of at least 4.5 minutes, at times, of at least 5 minutes, at times of at least 5.5 minutes, at times, of at least 6 minutes, at times of at least 7 minutes. Yet, with the limitation that the residence time does not cause decomposition or combustion the material within the extrusion. Thus, in some cases, the retention time is defined to be within the range of about 2 to about 10 minutes, at times between about 3 minutes to 7 minutes, at times between about 2.5 minutes and 10 minutes at times between about 3.5 minutes and 8 minutes, at times between about 4.5 minutes and 8 minutes, at times between about 5.5 minutes and 7 minutes, at times between about 5.5 minutes and 6.5 minutes.

An extruder typically comprises a heated barrel containing rotating therein a single screw or multiple screws. There are various types of extrusions that can be employed in the context of the present disclosure.

Without being bound by theory, it is believed that applying sheer forces on the sorted heterogenous waste, at material temperatures below 200° C. results in the conversion of organic fiber material (lignin, cellulose, hemicellulose, and other carbohydrates) to partially carbonized lignocellulosic fibers that act as natural “molecular stiches” integrating (binding) plastics, and particularly, polyolefins with different polarities that otherwise phase separate, and create an organic-thermoplastic composite material.

In some preferred examples, the extrusion is performed in a single screw extruder. It has been found that when using a single screw extruder, a minimal retention time should be of at least 3, or at least 4 and preferably at least 5 or 5.5 minutes.

In some examples, the single screw extrusion has dimensions that are designed to allow the above defined range of retention time. Those versed in the art would recognize how to design the diameter, length, die opening etc. of the extruder in order to achieve the desired retention time.

In some examples, the extruder is designed to operate at 30-10 rpm, at times at 40-90 rpm.

The running temperature within the extrusion (i.e. the internal temperature, in other words, the temperature of the material being extruded) can be controlled by Thermocouple, such as Thermocouple type J.

In some examples, the extruder is equipped with at least 2 or more venting zones. The presence of two distinct venting zones along the extruder reduces the amount of volatile organic compounds within the extruded material and prevents the entrapment of the volatile compounds. It has been found that the presence of at least two venting zones is important to avoid air voids in articles of manufacture made from the disclosed composite material (the articles of manufacture being molded or extruded articles).

Various additives can be added to the heterogenous intake material prior to extrusion. These include, without being limited thereto, any one or combination of zinc stearate, calcium stearate, antioxidants, UV stabilizers, blowing agents, plasticizers, elastomers, fillers e.g. talc and calcium carbonate; flame retardants and pigments like carbon black, titanium dioxide and other pigments as used in the plastics industry.

The composite material discharged from the extruder can then be subjected to further processing.

In some examples, the extrudate is subjected to controlled cooling.

In some examples, the cooling is by subjecting the extrudate to a cooling air flow. In some further examples, the controlled cooling is passing the extrudate on a conveyer and while conveying the extrudate, subjecting it to a cooling air flow. The cooling is gradual, which allows the further elimination of odor and VOC.

In some examples, the composite material discharged from the extruder is subjected to at least one refinement stage that involves size reduction of the composite material. This refinement is typically after the discharged composite material is cooled.

In some examples, the refinement involves milling of the composite material using any conventional milling system.

In some examples, the milling involves passing the composite material through a continuous milling process, such as a Hammer Mill (e.g. type 40/32 HA).

In some other examples, the extrudate is subjected to an Impact milling process, where high speed rotating blades (beater plates) smash the composite material against the enclosing walls and against itself, and the friction causes reduction in size.

In some examples, refinement can be achieved by subjecting the composite material to “Knife Mil” such as that achieved by using ROTOPLEX 50\100. The technology is designed to make high cutting forces with a high throughput. Using the principle of “scissors” a drum with knives moves at high speed in front of a counter knife in a cooled environment.

In some examples, refinement is done by a combination of two or more refinement techniques, e.g. a first making use of hammer mill technology and the second making use of impact milling technology. The combination of technologies allows for the reduction of the powder sider below 1.5 mm.

In some examples, the extrudate was subject to size reduction using a combination of milling devices set to grind the extrudate into powder (refined composite material), and by sieving through 900 μm (0.9 mm) or 1400 μm (1.4 mm) sieves, two populations of powders were obtained, one having a particle size below 0.9 mm (referred to herein by the abbreviated name “Q0.9”) and the other having a particle size below 1.4 mm (referred to herein by the abbreviated name “Q1.4”).

In some examples, the resulting powder is sieved, e.g. using Vibrational Sieve systems that sifts the particle size by using different sizes of holes in different diameters.

In some examples, size reduction is to a particle size defined by d90 equal or below 1.4 mm. At times, the size reduction is to a particle size of d90 equal or below 1.3 mm; at times equal or below 1.2 mm; at times equal or below 1.1 mm; at times equal or below 1.0 mm; at times equal or below 0.9 at times equal or below 0.8 mm; at times equal or below 0.7 mm.

In the following non-limiting examples, a refined composite material having a size of d90≤1.4 μm is referred to by the abbreviation Q 1.4; and a refined composite material having a size of d90≤0.9 mm is referred to by the abbreviation Q 0.9.

The resulting composite material and preferably the refined composite material can be reheated into a thermoplastic melt, by heating to a temperature above 100° C. In some examples, the composite material turns into a flowable molten upon heating to a temperature above 120° C.; at times, above 130° C.; at times, above 140° C.; at times, above 150° C.; at times, above 160° C.; at times, above 170° C.; and even above 180° C., at times to any temperature below 200° C., as long as the composite material does not undergo any decomposition or combustion as a result of the heating.

The melt can then be shaped into a desired article of manufacture, using any known technique, inter alia, extrusion injection, molding including blow molding and rotational molding. In this manner, articles of a defined configuration may be manufactured. For example, the composite material can be used to produce a variety of articles of manufacture which hare typically prepared from virgin plastics or recycled plastics. This includes, for example, flowerpots, housing siding, deck materials, flooring, furniture, laminates, pallets, septic tanks and the like.

Various additives, fillers, etc., may be added to the composite material upon reheating/reprocessing into useful articles of manufacture, to impart certain desired properties to the article eventually obtained after cooling. Examples of fillers may include, without being limited thereto, sand, minerals, recycled tire material, concrete, glass, wood chips, thermosetting materials, other thermoplastic polymers, gravel, metal, glass fibers and particles, etc. These fillers may originate from recycled products, however, virgin materials, such as virgin plastics (e.g. polypropylene and/or polyethylene) may also be employed. Other additives may be added to improve the appearance, texture or scent of the composite material such as colorants, odor masking agents (e.g. activated carbon), oxidants (e.g. potassium permanganate) or antioxidants. Nonetheless it is noted that the properties of the composite material of the present disclosure and its potential uses are attained without the need to use binders or plasticizers although these may be added under some embodiments.

To produce articles of manufacture, the composite material can be combined with some amount of plastics. This includes recycled plastic and virgin plastics.

In some examples, the composite material is reheated together with polyolefins. In some examples, the composite material is reheated with any one of polyethylene and polypropylene. The reheated mixture can be extruded into mixed pellets to be subsequently used as intake material in the plastic industry.

The composite material of the present disclosure as well as the material obtained by mixing the composite material with plastics can thus be processed through a variety of industrial processes, known per se, to form a variety of semi-finished or finished products.

As used herein, the forms “a”, “an” and “the” include singular as well as plural references unless the context clearly dictates otherwise. For example, the term “a particulate matter” includes one or more types of particulate matter having the recited characteristics.

Further, as used herein, the term “comprising” is intended to mean that the composite material include the recited components, i.e. non-plastic organics, plastics and inroganics, but not excluding other elements. The term “consisting essentially of” is used to define composite material which include the recited elements but exclude other elements that may have an essential significance on the properties of the composite material. “Consisting of” shall thus mean excluding more than trace elements of other elements. Embodiments defined by each of these transition terms are within the scope of this invention.

Further, all numerical values, e.g. the amounts or ranges of the components constituting the composite material or the heterogenous intake material disclosed herein are approximations which are varied (+) or (−) by up to 20%, at times by up to 10% of from the stated values. It is to be understood, even if not always explicitly stated that all numerical designations are preceded by the term “about”. For example, the term “about 10%” should be understood as encompassing the range of 9% to 11%; the terms about 100° C. denotes a range of 90 to 110° C.

The invention will now be exemplified in the following description of experiments that were carried out in accordance with the invention. It is to be understood that these examples are intended to be in the nature of illustration rather than of limitation. Obviously, many modifications and variations of these examples are possible in light of the above teaching. It is therefore, to be understood that within the scope of the appended claims, the invention may be practiced otherwise, in a myriad of possible ways, than as specifically described hereinbelow.

### DESCRIPTION OF NON-LIMITING EXAMPLES

### Example 1—Processing of Domestic Waste into a Composite Material

### Devices and Methods

In the following Examples various devices and systems were employed. It is to be understood that while some of the devices were constructed for the purpose of the present invention, all are based on conventional devices. These include a shredder, a single screw extruder, an injection molding machine, a compression molding press and any other machine in which the material undergoes shearing and/or heat, such as a granulator, pelletizing press, mill etc.

Specifically:

Bio-drying (Compost Bio-Drying Systems)—Bio-drying was activated by bacteria and multicellular organisms present in the household waste. This process occurs via the digestion of organic material by bacteria which creates heat. It is important that the household waste is loosely stratified under controlled conditions and ventilated with a precisely defined amount of air. This air must not be too cold or too humid while the blowing force is digitally controlled. Over a period of several days and up-to 2 weeks the municipal waste (MW) heats up and gains heat—of up to 70° C. The heat is regulated with a controlled supply of air and the optimum process temperature of around 55° C. to 70° C. is set. When the MW reaches a dryness level of about 15 to 20% water content, or even 15% to 18%, the activity of the bacteria decreases considerably, and the bi-drying process is considered complete.

Metal separating magnet (IFE MPQ 900 F-P) was used to separate out ferrous material. The metal separating magnet includes an electromagnet flying over a conveying belt; the coil creates a narrow and deep magnetic field that lifts out the ferrous metal parts and transports them a short distance through its own conveyor belt, thus separating the magnetic metals from the rest of the materials. Metals are disposed into a bin at the bottom of the system and sent back to recycling. The magnetic belt system is installed at the end of the conveyor belt and the box is positioned exactly above the flight parabola to catch magnetic materials.

Eddy current system (Wagner magnet 0429\0-37) was used to separate metals. Specifically, a 2.5 m wide Eddy current belt with neodymium high gradient magnets was used. The pole system was eccentrically installed inside a slower belt drum. The belt drum has an external speed of 1 to 3 m/s. The internal drum runs up to 3000 rpm. This creates an eddy current field that repels non-ferrous metals (which are thus removed) but attracts and heats ferrous metals. The separation force is highest with aluminum and decreases over brass, copper to the other non-ferrous metals.

Eddy current can be replaced with metal detectors to achieve similar results.

Shredder (Vecoplan VAZ 1300) was used to particulate the dried sorted waste. Specifically, two types were used: primary pre-crusher and secondary shredder

A pre-crusher is defined by one, two, three or four shafts coupled with hydraulic or electromechanical drives. The characteristic of primary pre-crushers is that a very large force is generated to break the waste into small pieces. Non-crushable materials that interfere with the secondary crushing can be separated. The shredding shafts used are mechanically connected to the shafts and the peripheral speed of the shafts is low.

The secondary shredding is positioned after the separation. The secondary shredding was done by means of 1 or 2 rotors mechanically connected with wear tools and counter blades, a screen basket was installed in front of the rotors to control the particle size.

Air separator system (IFE UFS600X+1000X) was used to separate between light and heavy particles. Specifically, the air separator/classifier consists of an acceleration belt on which the particles are positioned in one layer, and a subsequent air bar that blows an adjustable, defined air flow into the material. After the air bar, there is usually a separator between the light and heavy particles. Following the separation there is a divider space which gives the light parts the opportunity to sink down. The heavy materials are separated between the air bar and the separator.

Near Infra-Red system (SESOTEC MN 1024) was used to selectively sort out/separate out specific plastic polymers. Specifically, a system with a scanner and with active sensor support and active blow bar were used. In addition, the system was equipped with a high resolution NIR camera with at least 1.5 mm sensitivity, which captured the reflection of the IR spectrum of special substances and compares it with stored spectra of various substances. If the system detected a desired substance, the freely programmed function was queried in a binary form-separate or keep. The particles were then blown out with the same fineness as the detection using the connected blow nozzle bar.

The selective sorting resulted in a selective heterogenous waste, in particulate form, and comprising less than 1% PVC and less than 3% PS, and less than 5% PET.

Single Screw Extruder (Type F: GRAN 145) was used. Specifically, the single screw extruder had the dimensions of 145 mm diameter, screw length: 950 cm, clearance of screw to barrel: 0.5-2 mm, high wear resistant screw and barrel, die opening diameter of up to 30 mm and 2 venting zones. In operation, anti-bridging silo, rotors kept the Ready To Use (RTW, i.e. the sorted heterogeneous waste) in motion which prevented the material from bridging and ensures flowability. Feeder screw was automatically activated depending on the utilization of the extruder capacity.

After the extruder process the material was moved into a controlled cooling system with a cooling conveyor of 800 cm length and air flow of 15000 meters cubic meter per hour.

Milling devices—Several milling devices were employed to reduce size of the end-product, i.e. the composite material.

Hammer Mill type 40\32 HA—The Hammer Mill grinds soft to medium-hard pieces in a continuous process, in which the material underwent a process of particle mixing while grinding thus creating homogeneity.

Impact Mill (ULTRAPLEX UPZ 500)—The particle size was reduced to another level by using high-speed rotating blades (beater plate) which “hits” the particles to the walls and among themselves and where significant friction between the sides of the grinder (grinding tracks) and the beater plate reduces the material into a powder form. The resulting powder went through a Vibrational Sieve system that sifts the particle size by using different sizes of holes in different diameters.

The reduced size particles were conveyed then from the Hammer Mill through blowers to the next milling stage, the Impact Mill.

Knife Mil (ROTOPLEX 50\100)—particles of 0.9 mm size (and below) went directly to storage and so does the 1.4 mm. The particle size above 1.4 mm underwent further treatment using a “Knife Mil” (ROTOPLEX 50\100). Specifically, a knife mil is designed to make high cutting forces with a high throughput. Using the principle of “scissors” a drum with knives moves at high speed in front of a counter knife in a cooled environment. Via the knife mil system, particles (especially the fibers) were further reduced in size below 1.4 mm.

Elemental Analyzer (Flash EA 1112)—was used for determination of total carbon (C), hydrogen (H), nitrogen (N), sulfur(S) and oxygen (O).

Fourier-transform infrared spectroscopy (FTIR)—Nicolet 6700, Spectrophotometer for the Mid-Infra-Red range. Absorbance Spectra are obtained by recording the absorbance as a function of wavelength. Concentrations were calculated from absorbance measurements at specific wavelengths which are provided within the manufacturer's operating instructions and are based on commonly known libraries.

Thermogravimetry (TG)—Differential Scanning calorimetry (DSC)—STA TG-DSC 449 F3 Jupiter® (NETZSCH-Geratebau)—The simultaneous application of TG and DSC to a single sample in an STA instrument yields more information than separate application TG and DSC in two different instruments. STA enables simultaneous quantitative monitoring of mass- and thermodynamical changes which occur in the tested material under heating. Coupling of MS to the instrument for thermal analysis allows identification of materials/components being evolved during the heating experiment. Therefore, combination of STA TG-DSC with MS provides a unique straightforward tool for distinct experimental characterization of chemical reactions and phase transformation in a wide range of materials. The TG-DSC was operated under the following conditions:
Furnace—Silicon carbide
Temperature range—−150° ° C. to 1550° ° C.
Heating rates 0.001 K/min to 50 K/min
Cooling rate (free cooling)—1540 to 100° C.: 60 min
Weighing range—35 g
Max. Initial weight—35 g
Atmospheres—inert (N₂, Ar), oxidizing (dry air), reducing (Ar+5% H₂su), vacuum
Integrated Mass Flow Controller—for 2 purge gases and 1 protective gas
High Vacuum-Tight Assembly—up to 10⁻⁴ mbar (10⁻² Pa)

Gas chromatography-mass spectrometry (GC-MS)—Samples of the composite material were analyzed following a 24 hours Head-Space extraction, using a gas chromatography (GC) sniffer, followed by gas chromatography mass spectrometry (MS). Specifically, An Agilent 7890A GC was equipped with an auto sampler, a split/splitless injector and three detectors: FID and ECD and TCD. The GC was equipped with electronic control of gas pressures and flows.

Tensile tests—tensile properties were determined according to ISO 521-2:1996 using specimen type A1: overall length ≥150-200 mm, length of narrow parallel sided portion=80±2 mm, radius 20-25 mm, distance between broad parallel sided portions 104-113 mm, widths at ends=20±0.2 mm, width at narrow portion 10±0.2 mm, preferred thickness 4±0.2 mm, gauge length 50±0.5 mm and initial distance between grips=115±1 mm.

Impact Izod (notched)—Izod Impact was measured using ISO 180 (1 J Pendulum)/ASTM D256 (1 J Pendulum), Notched, Hammer 1 J. (Izod Impact Strength, edgewise notched specimens)

Charpy Impact—Charpy Impact test was conducted according to ISO 179, using Notched, Hammer 1 J (Charpy Impact Strength, edgewise notched specimens, according to ISO 179, Pendulum weight 1 J).

Flexural tests—The test was conducted using ASTM D790 (ISO 178) method, with test speed of 5 mm/min.

Ash content—Ash was determined according to ISO 3451 method A. Used two test portions of 5 gr each one and burned at 950-50° C. for 30 min.

Surface energy—Surface energy was measured ASTM D2578 using Dyne Pens.
Oxygen index—oxygen index was determined according to ISO 4589-2.
Density—density was measured using MRC Laboratory Instruments (model BPS750-C2V2), according to ASTM D792=ISO1183-1 procedure (Plastics—Methods for determining the density of non-cellular plastics). Specimen should be at least 1 cm³ and at least 1 mm thick (for each 1 gr of weight).

### Methods

Mixed household waste underwent a pre-sorting and bio-drying process. This process begins with the removal of metal particles, ferrous and non-ferrous using a metal separating magnet (type IFE MPQ 900 F-P)

In the next step the waste was passed through Eddy current (type Wagner magnet 0429\0-37), the pole system was installed inside a belt drum. The belt drum had an external speed of 1 to 3 m/s. The internal drum runs up to 3000 rpm. This created an eddy current field that repelled non-ferrous metals from the MW stream. At the end of this section, the waste was clean of metals and was transferred via a conveyor into a Bio-drying process (type Compost Systems). The waste at this stage typically contains a high water/humidity content-between 30% to 50% and the bio-drying was designed and controlled to reduce moisture level to below 20%.

The bio-dried MW was then subjected to shredding to obtain waste particle size of not more than (up to) 30 millimeters. Particle shredded at or below 30 millimeters were removed through a dedicated basket while larger particles continued to rotate in the shredder until they reached the desired size. Notably, the shredding created some friction which further reduced moisture by 2%-3%. The shredded particles became more uniform allowing the next stages of the process to work more efficiently.

Following the shredding, some of the impurities that were “glued” or wrapped in the shredded waste particles were released by an air separator system. The shredded material went into an air separator (Air classifier (type IFE UFS600X+1000X)) system that eliminates any reminiscent parts of heavy particles (metals or minerals) from the shredded material (resulting in the formation of a “light fraction”).

The light fraction was then conveyed to the NIR separation system where the halogenated polymer such as PVC and aryl containing synthetic polymers such as polystyrene and/or PET were selectively removed.

The material following the NIR separation provided the sorted heterogenous intake material which was then subjected to extrusion. The extruder was operated to have a running temperature of between 150° C. and 180° C., residence time of 5-7 minutes and rotating speed of 60-90 rpm.

After passing the extruder process, the resulting molten material was cooled to 40° C. via a cooling conveyor (800 cm length and air flow of 15000 cubic meter per hour).

The cooled composite material was subjected to size reduction/size refinement by passing the same through a Hammer Mill followed by an Impact Mill and the refined particles were then selectively sieved to provide either Q0.9 (particles of up to 0.9 mm) or Q1.4 (particles of up to 1.4 mm) products.

### Example 2—Analysis and Characterization

### DNA Extraction and Chlorophyll Content of Q0.9 and Q1.4

DNA extraction protocol was modified from http://www.bio-protocol.org/e2906. Specifically, triplicates of 20 g of Q 0.9 and Q 1.4 were ground in liquid nitrogen to a fine powder using a cooled mortar and pestle (this being a common method for extraction of DNA LN2 in −210 C). The fine powder was then placed into a tube, to which 500 ul 2% chloroform:isoamyl alcohol (24:1) (CTAB) solution was added and incubated with vigorous mixing, in a 65° C. water bath for one hour. The use of CTAB, a cationic detergent, facilitates the separation of polysaccharides during purification while additives, such as polyvinylpyrrolidone, can aid in removing polyphenols. CTAB based extraction buffers are widely used when purifying DNA from plant tissues.

The mixture was then centrifuged at 12,000 g for 15 min and supernatant was collected, to which an equal volume of chloroform was added and centrifuged again. The aqueous phase was taken, and an equal volume of isopropyl alcohol was added by mixing the tube gently. The tubes were placed in −20° C. for one h and Centrifuged for 12,000×g for 15 min. 700 μl 75% ethanol was added to the pellet and centrifuged for 12,000×g for 5 min. The pellet dried entirely and was mixed in 30μl ultrapure water 1 ul 10% RNaseA and incubated at 37° C. for one hour. DNA amount was determined using NanoDrop.

Chlorophyll content determination was done using a protocol modified from http://www.bio-protocol.org/e2906. Specifically, Triplicates of 20 mg mass of Q were added into a 1.5 ml tube containing 1 ml of dimethylformamide (DMF). The tubes were incubation overnight at 4° C. to allow the chlorophyll to dissolve into the DMF solution. 300 μl of sample solution was mixed with 600 μl of DMF in a fresh Eppendorf tube (2 volumes of DMF per volume of sample). The absorbance (A) was taken in a spectrophotometer at 647 nm and 664.5 nm wavelengths using a Quartz cuvette.

$$\begin{matrix}Chlorophll a content ( μg / ml ) = ( 12 \times {A}_{664.5} ) - ( 2.79 \times {A}_{647} ) \\ Chlorophll b content ( μg / ml ) = ( 20.78 \times {A}_{647} ) - ( 4.88 \times {A}_{664.5} )\end{matrix}$$

TABLE 1
total DNA and Chlorophyll content

| | Q 0.9 | Q 1.4 |
|---|---|---|
| Chlorophyll μg/g | 97 | 96 |
| DNA mg/g | 5 | 3 |

### Elemental Analysis (C, H, N) of O Materials

Elemental analysis of C, H, N, S and O was conducted using Flash EA 1112 Elemental Analyzer, according to manufacturers instructions.

TABLE 2
Elemental Analysis (organics)

| % | N | C | H |
|---|---|---|---|
| Q 0.9 | 0.6 | 53.8 | 7.6 |
| Q 1.4 | 0.5 | 54.7 | 7.9 |

### ICP—Atomic Emission Spectrometry

Q0.9 and Q 1.4 samples were digested by Microwave Digestion System (Milestone Ethos-1) and analyzed by ICP-AES (axial) (Spectro ARCOS-EOP) and ICP-AES (radial) (Spectro ARCOS-SOP) as described hereinabove.

The resulting data is provided in Table 3.

TABLE 3
Elemental Analysis (inorganics)

| Element mg/kg | Q 0.9 | Q 1.4 | Element | Q 0.9 | Q 1.4 |
|---|---|---|---|---|---|
| Ag | 0.7585 | 0.1026 | Mn | 38.9 | 22.4 |
| Al | 3111 | 3731 | Mo | 1.94 | 1.03 |
| As | <0.4 | <0.4 | Na | 3953 | 2873 |
| B | 17.3 | 13.0 | Ni | 10.93 | 6.38 |
| Ba | 141.7 | 24.2 | P | 651 | 2485 |
| Ca | 29647 | 25814 | Pb | 28.3 | 2.64 |
| Cd | 0.841 | 0.052 | S | 1434 | 1129 |
| Co | 3.46 | 1.76 | Sb | 12.3 | <0.7 |
| Cr | 23.2 | 15.4 | Se | <0.5 | <0.5 |
| Cu | 64.0 | 13.1 | Si | 1732 | 1010 |
| Fe | 1333 | 942 | Sn | 10.55 | 9.35 |
| Hg | <0.57 | <0.57 | Sr | 57.7 | 67.4 |
| K | 2130 | 1543 | Ti | 28.3 | 13.6 |
| Li | 1.47 | 0.56 | V | 1.98 | 1.21 |
| Mg | 1189 | 875 | Zn | 136.0 | 40.9 |

Interestingly, Table 3 shows that both Q0.9 and Q1.4 contain high levels of potassium and magnesium (see also Table 13).

### Fourier-Transform Infrared Spectroscopy (FTIR)

FTIR Spectrometry was conducted using Nicolet 6700, using ATR Accessory as described hereinabove.

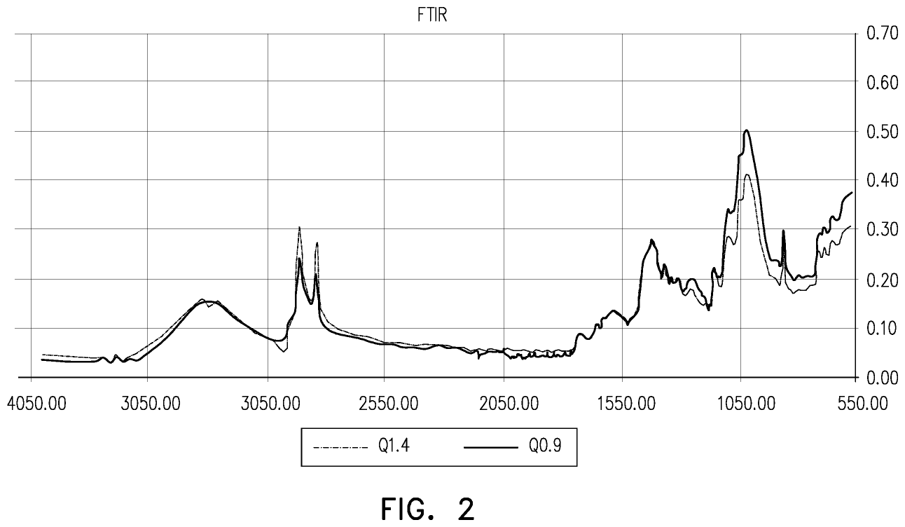

FIG. 2 provides the results for two different samples, including the composite material of 0.9 mm dimensions (Q0.9) and the composite material of 1.4 mm dimensions (Q1.4).

Interestingly, FTIR library identified Q0.9 as Lutein (86%) and Q 1.4 as Newsprint (black ink) (92%). While this cannot be regarded as a definitive chemical identification, this is an interesting observation and clear differentiator between Q0.9 and Q1.4 and from other wood plastics. While Q 1.4 is relatively rich in cellulose fibers, Q 0.9 contained less fibers and higher proportion of smaller molecules like Lutein.

### Thermogravimetry Analysis (TGA)—Differential Scanning Calorimetry (DSC)

The TGA measures the weight loss as a function of temperature. A loss of 5% means start of degradation. The composite material disclosed herein was found to be more stable than the composite material disclosed in WO2010/082202, the content of which is incorporated herein by reference (see also Table 13 below). Q0.9 was stable at up to 218° C. and Q1.4 was stable at up to 224° C. Notably, the higher the degradation begins the processing window is wider.

The methodology used to analyze the organic/inorganic compounds found in the tested samples of Q0.9 and Q1.4 was based on thermal analysis methods, as follows:
a. Differential Scanning Analysis (DSC) to determine the relative amount of synthetic polymers.
b. Thermogravimetric Analysis (TGA) to determine the thermal stability (Tₒₙₛₑₜ and T₀), the amount of inorganic material (ash content) and the approximate amount of lignocellulosic components.

### Results

Lignocellulose content—appr. 350° C. (from TGA)
Inorganic content—ash content >650° C. (from TGA)

Coupling of MS to the instrument for thermal analysis allows identification of materials/components being evolved during the heating experiment.

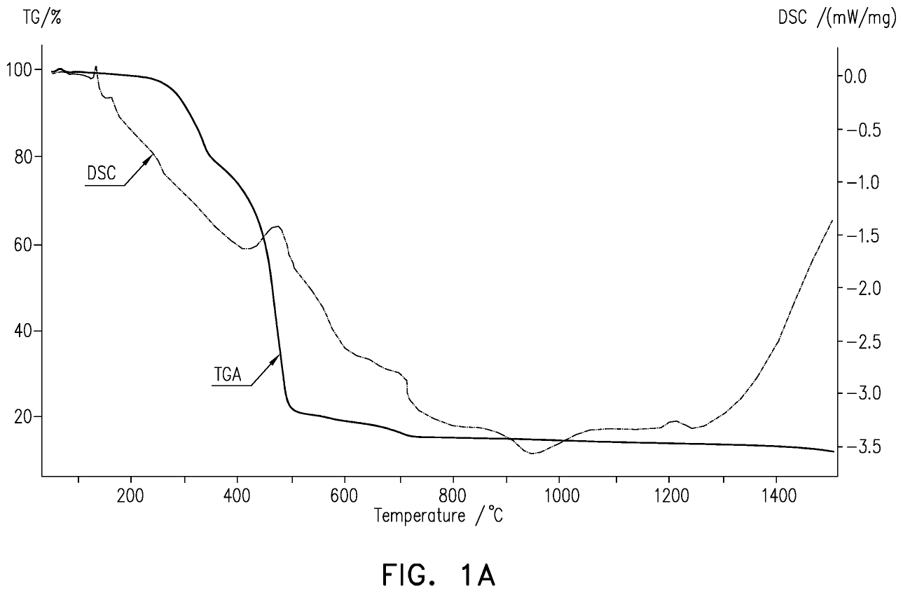

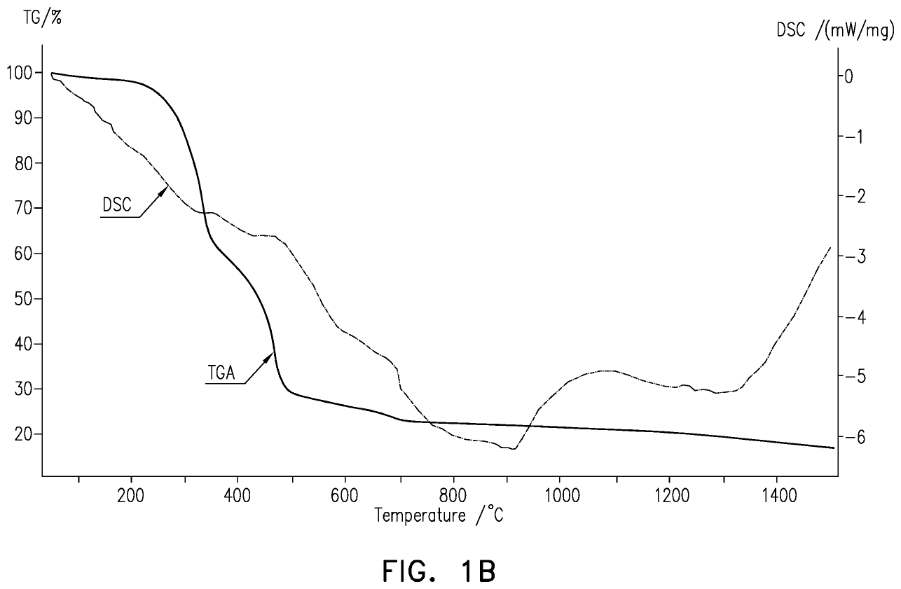

Table 4 and FIGS. 1A-1B provide the thermal stability of the composite materials disclosed herein, i.e. Q 0.9 and Q 1.4.

TABLE 4
Q0.9 and Q1.4 Thermal stability

| Time point | Q 0.9 | Q 1.4 |
|---|---|---|
| T onset (Weight loss onset, i.e. the temperature | 218° C. | 224° C. |
| when oxidation Degradation begins) | | |
| T₀ (Oxidation Degradation temperature, the | 298° C. | 299° C. |
| temperature of the maximum in weight loss rate) | | |

FIG. 1A shows TG-DSC of Q1.4 from 0 to 1500 degrees Celsius in 50 degrees increase every one minute.

FIG. 1B shows TG-DSC of Q0.9 from 0 to 1500 degrees Celsius in 50 degrees increase every one minute.

As appreciated, the TGA peaks in each of the graphs show the change in mass with the beginning of decrease at Tₒₙₛₑₜ and the greatest decrease at T₀. While the DSC graphs show the resulting energy release. These two Figures show that the composites are stable at temperatures above 210° C.

The composition of each sample, Q0.9 and Q1.4 was also determined by the coupled MS and the data is presented in Table 5.

TABLE 5
Q0.9 and Q1.4 Composition by TG-DSC Thermal characterization

| | Q 0.9 | Q 1.4 |
|---|---|---|
| Cellulose (%) | 79.2% | 78.2% |
| Synthetic (non-organic) | 11.6% | 15.3% |
| Polymers (%) | | |
| Inorganic (%) | 9.2% | 6.5% |

### Total Extracted Carbon

Total extracted carbon was determined using 20 g Q 0.9 and Q 1.4, extracted with Di-Methyl Ether (DME). The oil residue was weighed, and the amount of extracted carbon was calculated. The results are shown in Table 6.

TABLE 6
Total extracted Carbon

| | Q 0.9 | Q 1.4 |
|---|---|---|
| Carbon content (gr) | 0.7 | 0.56 |
| Carbon content (%) | 3.5 | 2.8 |

It is noted that both Q 0.9 and Q 1.4 contained significant amounts of extracted carbon. DME is an organic solvent degrades. Therefore, it is assumed that most of the carbon content is from fatty acids. This is also verified by the GC-MS below.

### Tensile Tests

Samples for tensile tests were prepared as follows: the composite material was extruded at 170-180° C. and 350 rpm using a ZSK 18 lab extruder, to obtain a homogenous material. The extrudate was ground by the lab granulator and the granulated material was injection molded by the Haitian 120 t at 170-180° C., to make test specimens. The test specimens were conditioned for at least 48 hours at 23±2° C.

Measurements of tensile properties of the injection molded sample were provided using ISO 521-2:1996.

Specimen Type 1A comprised the following dimension: overall length ≥150-200 mm, length of narrow parallel sided portion=80±2 mm, radius 20-25 mm, distance between broad parallel sided portions 104-113 mm, widths at ends=20±0.2 mm, width at narrow portion 10±0.2 mm, preferred thickness 4±0.2 mm, gauge length 50±0.5 mm and initial distance between grips=115±1 mm.

At least 5 specimens were tested by Tinius Olsen H10KT apparatus. Test speed 50 mm/min. The test results are the average of these measurements.

Table 7 provides a summary of the physical properties.

TABLE 7
Physical properties

| Physical Property | Q 0.9 | Q 1.4 |
|---|---|---|
| Tensile modulus (MPa) | 2260 | 1740 |
| Break stress (MPa) | 11.8 | 12.2 |
| Max Force (N) | 484 | 505 |
| strain at Max Stress (%) | 1.02 | 1.48 |
| Yield Stress (MPa) | 12.1 | 12.3 |
| Yield strain (%) | 0.97 | 1.29 |
| Yield Force (N) | 484 | 493 |
| Total elongation (%) | 1.18 | 1.74 |

### Impact Izod (Notched)

Notched Izod Impact is a single point test that measures a materials resistance to impact from a swinging pendulum. Izod impact (notched) is defined as the kinetic energy needed to initiate fracture and continue the fracture until the specimen is broken.

At least 5 specimens were tested by Tinus Olsen Impact apparatus, model 503 (Pendulum weight 1 J). The test results are provided in Table 8, which are the average of these measurements.

TABLE 8
Izod Impact (notched)

| | Q 0.9 | Q 1.4 |
|---|---|---|
| Strength (kJ/m², ISO 180) | 2.1 | 3.0 |
| Strength (J/m, ASTM D256) | 21.8 | 28.0 |
| Statue of break* | C | H |

*N—Non/P—Partial/C—Complete/H—Hinge

The Q0.9 and Q1.4 showed an improved Izod impact as compared to the composite material of WO2010/082202 (see also Table 13).

### Charpy Impact

Charpy Impact test is a single point test that measures a materials resistance to impact from a swinging pendulum. Charpy impact is defined as the kinetic energy needed to initiate fracture and continue the fracture until the specimen is broken. The values obtained can be used for quality control or to differentiate general toughness.

At least 5 specimens were tested by Tinus Olsen Impact apparatus, model 503 (Pendulum weight 1 J). The results presented in Table are the average of these measurements.

Charpy Impact of Q 0.9 and Q 1.4 is provided in Table 9.

TABLE 9
Charpy Impact

| | Q 0.9 | Q 1.4 |
|---|---|---|
| Strength (kJ/m², ISO 179) | 2.3 | 3.1 |
| Strength (J/m, ASTM D256) | 18.0 | 24.3 |
| Statue of break* | C | H |

*N—Non/P—Partial/C—Complete/H—Hinge

The Q0.9 and Q1.4 showed an improved Charpy impact as compared to the composite material of WO2010/082202 (see also Table 12).

### Flexural Tests

The flexural test measures the force required to bend a beam under three-point loading conditions. The data is often used to select materials for parts that will support loads without flexing. Flexural modulus is used as an indication of a material's stiffness when flexed.

At least 5 specimens were tested by Tinius Olsen H10KT apparatus. The results, presented in Table 10, are the average of these measurements.

TABLE 10
Flexural test results (ISO 178)

| | Q 0.9 | Q 1.4 |
|---|---|---|
| Flexural modulus (Mpa) | 2900 | 2100 |
| Ultimate force (N) | 40.9 | 42.3 |
| Flexural strength, (Mpa) | 23.8 | 24.6 |
| Total elongation (%) | 1.8 | 2.9 |

### Ash Content

An Ash test was used to determine if Q0.9 or Q1.4 are filled. The test typically identifies the total filler content or inorganic content. Test samples were 5 g each.

Ash content results of Q 0.9 and Q 1.4 are 10.4% and 7.9%, respectively.

It is noted that a low ash content means low amount of minerals in the composite leading to better thermoplastic properties. In comparison to the composite material of WO2010/082202, it is clear that the composite material disclosed herein has a significantly lower ash content.

### Surface Energy

The strength of attraction between a material and a coating is determined by the relative surface energy/surface tension of the materials. The higher the solid's surface energy relative to the liquid's surface tension, the greater the molecular attraction, this draws the paint, ink or adhesive closer for high bond strength. The lower the solid's surface energy relative to the liquid's surface tension the weaker the attractive forces are and this will repel the coating.

Surface energy of Q 0.9 and Q 1.4 were found to be the same, of 36 dyne/cm. With respect to the surface energy, it is noted that for most solvent based printing, plastics need to be treated to 36 to 40 dynes/cm. Thus Q 0.9 and 01.4 display a very good surface energy, unlike common plastics.

### Oxygen Index

For determination of Burning Behavior by Oxygen Index, a test specimen is supported vertically in a mixture of oxygen and nitrogen flowing upwards through a transparent chimney. The upper end of the specimen is ignited, and the subsequent burning behavior of the specimen is observed. The period for which burning continues, or the length of the specimen burnt are compared with specified limits for such burning. By testing a series of specimens in different oxygen concentrations, the minimum oxygen concentration is estimated.

According to the above, the oxygen index of Q 0.9 was 21.3%.

### Density

The density is the ratio of the mass of a sample to its volume expressed in kg/m³. To determine the density, the sample was conditioned over 40 hours at 23° C.±2° C. and 50±5% room humidity. The volume of the specimen was not less than 1 cm³ and its surface and edges were smoothened. The thickness of the specimen was at least 1 mm for each 1 g of weight. A specimen weighing 1 to 5 g was found to be convenient, but specimens up to approximately 50 g are also acceptable.

For density determination, a specimen is weighed in air (A) and then again in the auxiliary liquid (B) with a known density, in this example, ethanol.

The density of the solid p is then calculated according to the following equation:

$$ρ = \frac{A}{A - B} ( {ρ}_{0} - {ρ}_{L} ) + {ρ}_{L}$$

ρ=Density of the specimen
A=Weight of the specimen in air
B=Weight of the specimen in the auxiliary liquid (ethanol)
ρ₀=Density of the auxiliary liquid (ethanol)
ρ_{L}=Density of air
   The density of ethanol is 789 kg/m³ and that of air is 1.225 kg/m³.
   The density is determined at standard room temperature of 23° C.±2° C.
   The density of Q1.9 and Q1.4 at 23° C. vis-à-vis ethanol are provided in Table 11.

TABLE 11
Density

| | Q 0.9 | Q 1.4 |
|---|---|---|
| Density (g/cm³) | 1.20 | 1.12 |

The desire is to obtain a low-density product as plastics are sold on a cost per pound basis and a lower density (or lower specific gravity) would mean more material per weight unit. As shown in Table 13, the densities of Q0.9 and Q1.4 were lower than the composite material described in WO2010/082202.

### Example 3—Comparison with Composite Material of WO2010/082202

To evaluate the superiority of the composite materials disclosed herein, a comparison with the composite material disclosed in WO2010/082202 was made. Table 12 provides the comparison.

TABLE 12
Comparison with WO2010/082202

| | | WO2010/082202 | | |
|---|---|---|---|---|
| Parameter | Units | (Support) | Q0.9 | Q1.4 |
| Surface energy | dyne/cm | 44-48 | 36 | 36 |
| | | (Tables 3 & 12) | | |
| Density | g/cm³ | 1.35-1.55 | 1.20 | 1.12 |
| | | (Table 3 & 8) | | |
| TGA | ° C. | 170 | 218 | 224 |
| | | (FIG. 3 + 4) | | |
| Tensile | MPa | 5.13-6.25 | 12.1 | 12.3 |
| Strength | | (Tables 8& 9) | | |
| Tensile | MPa | 686-1,160 | 2,260 | 1,740 |
| Modulus | | (Tables 8&9) | | |
| Flexural | MPa | 830-1,935 | 2,900 | 2,100 |
| Modulus | | (Tables 8&9) | | |
| Flexural | MPa | 7.68-13.3 | 23.8 | 24.6 |
| Strength | | (Tables 8&9) | | |
| Izod Impact | KJ/m² | 1.2 | 2.1 | 3.0 |
| notched | | (Page 25, 12 KJ/m) | | |
| Charpy | KJ/m² | 1.39-2.22 | 2.25 | 3.06 |
| Impact | | (Table 8& 9) | | |
| Specific | kJK⁻¹Kg⁻¹ | 4.4 | ND | ND |
| Heat | | (Table 3) | | |
| Flame | % | 22 | 21.3 | ND |
| Retardancy | | | | |
| (LOI) | | | | |
| DNA | | + | + | + |
| Chlorophyl | | + | + | + |
| Ca | mg/g | 24.7-32 | 29.6 | 25.8 |
| | | (Table 2) | | |
| Fe | mg/g | 4.4-6.54 | 1.3 | 0.9 |
| | | (Table 2) | | |
| Na | mg/g | 7 | 4.0 | 2.9 |
| | | (Table 2) | | |
| Al | mg/g | 10.5-13.9 | 3.1 | 3.7 |
| | | (Table 2) | | |
| K | mg/g | 2.19 | 2.1 | 1.5 |
| | | (Table 2) | | |
| Mg | mg/g | 6.14 | 1.2 | 0.9 |
| | | (Table 2) | | |
| P | mg/g | 0.66 | 0.7 | 2.5 |
| | | (Table 2) | | |
| Zn | mg/g | 0.36 | 0.1 | 0.0 |
| | | (Table 2) | | |
| Si | mg/g | 71.3 | 1.7 | 1.0 |
| | | (Table 2) | | |
| S | mg/g | 0.74 | 1.4 | 1.1 |
| | | (Table 2) | | |

+—indicates that the element was found to be present

1. A composite material comprising a homogenous blend of:
a. at least about 40% w/w of non-plastic organic matter out of a total weight of the composite material, the non-plastic organic matter comprising at least cellulose; and
b. between about 10% w/w and about 60% w/w plastic matter out of a total weight of the composite material, the plastic matter comprising a plurality of synthetic thermoplastic polymers;
c. up to 15% w/w inorganic matter;
wherein the composite material comprises aryl containing synthetic polymers in an amount of less than 10% out of the total weight of the composite material; and
wherein said plastic matter comprises a heterogenous blend of plastics, including more than two polyolefins and more than two non-polyolefins;
wherein the composite material is characterized by at least one of the following properties:
a notched izod impact of at least 15 KJ/m²; and
wherein, when a sample of the composite material is subjected to injection molding to form a molded sample, the molded sample has at least one of:
a tensile strength of at least 8 Mpa and
a flexural strength of at least 15 MPa.

2. (canceled)

3. The composite material of claim 2, further comprising PET in an amount of less than 5% out of the total weight of the composite material.

4. The composite material of claim 1, being characterized by at least one of the following features:
the composite material has a density of equal to or less than 1.2 gr/cm³;
the composite material has a thermal gravimetry analysis (TGA) temperature above 200° C.;
the molded sample of the composite material has at least one of:
a tensile strength the of at least 10 MPa;
a tensile modulus of at least 1,500 MPa;
a flexural modulus of at least 1,500 MPa; and
a flexural strength of at least 20 MPa; and
the composite material comprises less than 5 mg/g silicates.

5. The composite material of claim 1, comprising halogenated polymers in an amount of less than about 1% w/w out of the total weight of the composite material.

6. The composite material of claim 1, having a density of equal to or less than 1.2 gr/cm³.

7. The composite material of claim 1, having a thermal gravimetry analysis (TGA) temperature above 200° C.

8. The composite material of claim 1, wherein in the molded sample of the composite material has
a tensile strength the of at least 10 Mpa;
a tensile modulus of at least 1,500 MPa;
a flexural modulus of at least 1,500 MPa; and
a flexural strength of at least 20 MPa.

9. The composite material of claim 1, comprising less than 5 mg/g silicates.

10. The composite material of claim 1, comprising refined particles having a size distribution of d90 equal or below 1,500 μm as measured by sieving through 1,500 μm sieves.

11. The composite material of claim 10, in a form of comprising refined particles having a size distribution of d90 being equal or below 900 μm, as measured by sieving through 900 μm sieves.

12. A method of preparing a composite material, the method comprises:
a. subjecting particulate heterogenous intake material to at least one extrusion process within an extruder, at a temperature maintained within a range of 150° C. and 200° C., to thereby obtain the composite material;
wherein the particulate heterogenous intake material comprises:
i. at least 40% w/w of non-plastic organic matter out of a total weight of the particulate heterogenous intake material, the non-plastic organic matter comprising at least cellulose; and
ii. between about 510% w/w and about 60% w/w plastic matter out of a total weight of the composite material, the plastic matter comprising a plurality of synthetic thermoplastic polymers, including more than two polyolefins and more than two non-polyolefins;
iii. up to 15% w/w inorganic matter out of a total weight of the composite material; and
wherein the heterogenous intake material comprises aryl-containing synthetic polymers in an amount of less than 10% out of the total weight of the composite material.

13. The method of claim 12, wherein the heterogenous intake material comprises halogenated polymers in an amount of less than about 1% w/w out of the total weigh of the composite material.

14. The method of claim 12, wherein the aryl-containing synthetic polymers comprises polyethylene terephthalate (PET).

15. The method of claim 12, wherein the heterogenous intake material comprises PET in an amount of less than 5% out of the total weight of the composite material.

16. The method of claim 13, comprising subjecting the particulate heterogenous intake material to at least one separation step prior to the at least one extrusion process, the separation step comprises a removal of one or both of the halogenated polymers and the aryl-synthetic polymers from the particulate heterogenous intake material based on Near Infra-Red (NIR) absorbance, to obtain a sorted heterogenous intake material.

17. The method of claim 12, further comprising:
subjecting heterogenous waste to two or more particulating and sieving stages to obtain the particulate heterogenous intake material.

18. (canceled)

19. The method of claim 12, further comprising:
subjecting the composite material to at least one refining stage comprising a size reduction of the composite material.

20. The method of claim 19, wherein the size reduction is to a size defined by d90 of not more than 1,500 mm.

21. An article of manufacture comprising a homogenous blend of a composite material as claimed in claim 1 and at least one polyolefin.

22. A method of producing an article of manufacture, the method comprises processing a composite material of claim 1 together with at least one polyolefin, wherein the processing comprises at least one of extrusion and molding, and wherein the processing provides homogenous blending of the composite material with the at least one polyolefin.
